(19) United States
(12) Patent Application Publication
(10) Pub. No.: US 2016/0160472 A1
(43) Pub. Date: Jun. 9, 2016

(54) System for Determining a Position of a Component

(71) Applicant: Caterpillar Global Mining LLC, Oak Creek, WI (US)

(72) Inventors: Lukas C. Voda, Franklin, WI (US); Eric M. Boman, Mukwonaco, WI (US); Peter J. Miller, Brookfield, WI (US); Robert Weber, Oak Creek, WI (US); Omar Abdel-Baqi, Oak Creek, WI (US)

(73) Assignee: CATERPILLAR GLOBAL MINING LLC, Oak Creek, WI (US)

(21) Appl. No.: 14/563,662

(22) Filed: Dec. 8, 2014

(51) Int. Cl. E02F 9/26; E02F 9/20; E02F 9/24; G01C 9/02

(52) U.S. Cl. CPC E02F 9/264; G01C 9/02; E02F 9/2029; E02F 9/2033; E02F 9/2037; E02F 9/24

(57) ABSTRACT

A system for determining a position of a first component relative to a second component includes a first sensor mounted on the first component and configured to generate first position signals indicative of a position of the first component, and a reference sensor mounted on the second component and positioned adjacent the first sensor and configured to generate reference position signals indicative of a position of the second component. A controller is configured to receive the first position signals, receive the reference position signals, and determine a position of the first component relative to the second component based upon both the first position signals and the reference position signals.

### TECHNICAL FIELD

This disclosure relates generally to a position sensing system and, more particularly, to a system for precisely determining the position of one or more components.

### BACKGROUND

Many different types of machines utilize work implements or tools to transfer material from a work site to another location, such as haul or transport vehicles. Examples of these machines include excavators, backhoes, loaders, and various other machines for moving dirt, gravel, stone, or other material.

Control of the machines can be a complex task requiring a significant amount of skill on the part of an operator and typically requires manipulation of multiple input devices such as joysticks. An example may be the movement of a work implement or tool, such as a bucket, along a desired path in a consistent, controlled manner from a first location, such as a dig location, to a second location, such as a dump location. Upon reaching the dump location, the operator may operate the input devices to slow down the movement of the tool in order to accurately position the tool and, in the case of a bucket, minimize any spillage from the bucket as it reaches its desired dump location.

In some instances, in order to increase rate of a loading operation, the operator may move the tool as fast as possible and allow the machine to reach conflict positions at which either components of the linkage engage each other or hydraulic cylinders reach their ends of travel. To reduce wear on the machine, systems are sometimes used to slow movement of the tool as it nears an end of travel position. In some situations, the systems rely upon limit switches to define an area at which movement may be slowed or prevented altogether.

U.S. Pat. No. 5,968,104 discloses a hydraulic excavator having an area limiting excavation control system. The area limiting excavation control system has a setting device permitting an operator to set an excavation area at which an end of a bucket is allowed to move. The excavation control system limits the speed of the bucket based on the machine parameters such as speed, load, position, posture, and temperature. As the bucket nears a boundary of the operator set excavation area during a movement operation, the speed of the bucket is slowed in the direction of the boundary such that the bucket stops at the boundary of the excavation area without exiting the desired excavation area.

The foregoing background discussion is intended solely to aid the reader. It is not intended to limit the innovations described herein, nor to limit or expand the prior art discussed. Thus, the foregoing discussion should not be taken to indicate that any particular element of a prior system is unsuitable for use with the innovations described herein, nor is it intended to indicate that any element is essential in implementing the innovations described herein. The implementations and application of the innovations described herein are defined by the appended claims.

### SUMMARY

In one aspect, a system for determining a position of a first component relative to a second component includes the second component being pivotably mounted to the first component and movable relative to the first component, a first sensor mounted on the first component and configured to generate first position signals indicative of a position of the first component, and a reference sensor mounted on the second component and positioned adjacent the first sensor and configured to generate reference position signals indicative of a position of the second component. A controller is configured to receive the first position signals, receive the reference position signals, and determine a position of the first component relative to the second component based upon both the first position signals and the reference position signals.

In another aspect, a controller-implemented system for determining a position of a first component relative to a second component includes receiving first position signals from a first sensor mounted on a first component, receiving reference position signals from a reference sensor mounted on a second component, pivoting the first component relative to the second component, and determining a position of the first component relative to the second component based upon both the first position signals and the reference position signals.

In still another aspect, a machine includes a prime mover, a first component, and a second component pivotably mounted to the first component and movable relative to the first component. A first sensor is mounted on the first component and is configured to generate first position signals indicative of a position of the first component. A reference sensor is mounted on the second component, is positioned adjacent the first sensor, and is configured to generate reference position signals indicative of a position of the second component. A controller is configured to receive the first position signals, receive the reference position signals, and determine a position of the first component relative to the second component based upon both the first position signals and the reference position signals.

### BRIEF DESCRIPTION OF THE DRAWINGS

FIG. 1 is a side view of a hydraulic shovel including a position sensing system in accordance with the disclosure and with an adjacent target vehicle;

FIG. 2 is a fragmented view of a portion of the implement system of the hydraulic shovel of FIG. 1 with certain parts;

FIG. 3 is a simplified schematic view of a control system within the hydraulic shovel of FIG. 1; and

FIG. 4 is a diagrammatic view of a portion of the implement system of the hydraulic shovel of FIG. 1.

### DETAILED DESCRIPTION

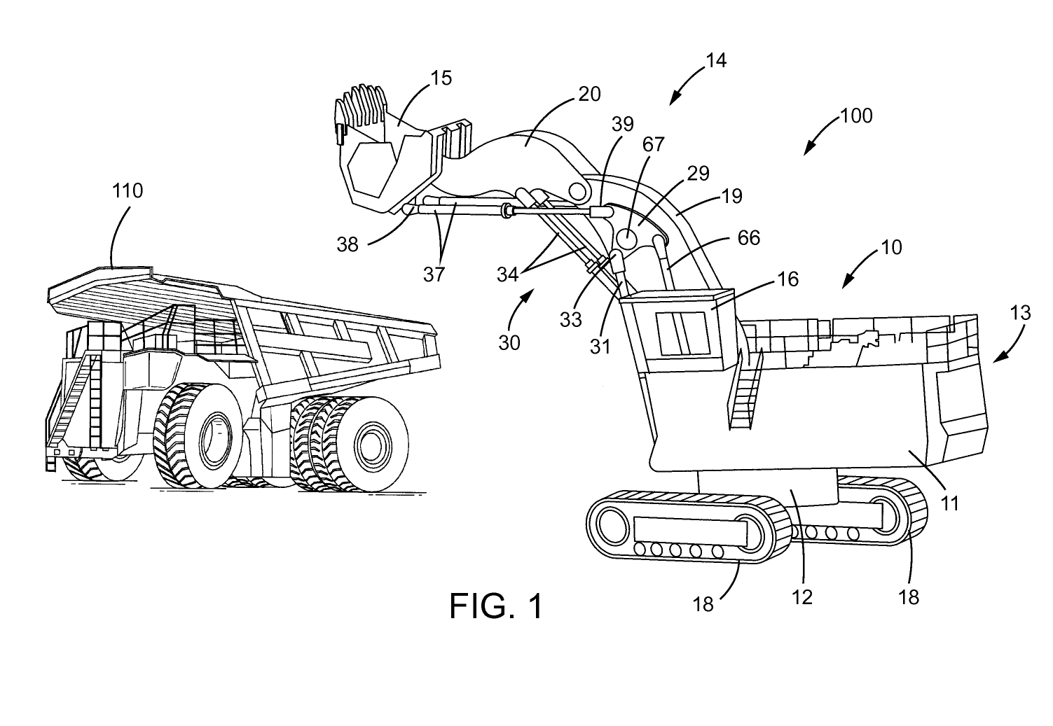

FIG. 1 illustrates an exemplary machine 10 such as an excavator having multiple systems and components that cooperate to perform an operation such as excavating earthen material from a dig site 100 and loading it onto a nearby target such as haul machine 110. Machine 10 may include a swing member or platform 11, an undercarriage 12, a prime mover 13, and an implement system 14 including a work implement or tool 15 such as a bucket. Other types of work implements may also be used.

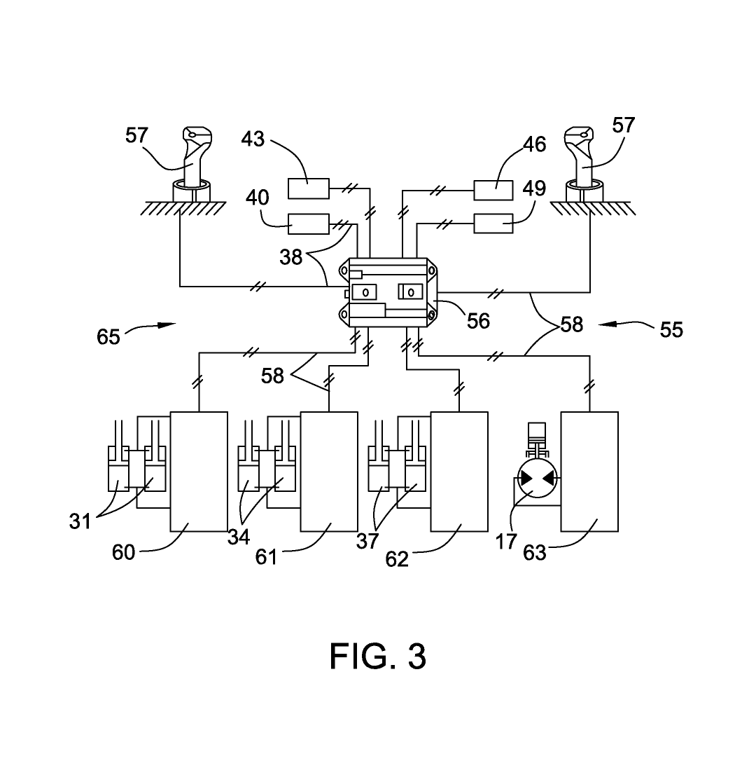

Platform 11 may be rotatably disposed on undercarriage 12 and includes an operator station 16 from which an operator may control the operation of machine 10. Rotation of platform 11 relative to undercarriage 12 may be effected by a swing motor 17 (FIG. 3).

Undercarriage 12 may be a structural support for one or more ground-engaging traction devices. The ground engaging fraction devices may include one or more tracks 18 configured to allow translational motion of machine 10 across a work surface. Alternatively, the ground engaging fraction devices may include wheels, belts, or other traction devices known in the art.

A prime mover 13 may provide power for the operation of machine 10. Prime mover 13 may embody a combustion engine, such as a diesel engine, a gasoline engine, a gaseous fuel powered engine (e.g., a natural gas engine), or any other type of combustion engine known in the art. Prime mover 13 may alternatively embody a non-combustion source of power, such as a fuel cell or a power storage device such as a battery coupled to a motor. Prime mover 13 may provide a rotational output to tracks 18, thereby propelling machine 10. Prime mover 13 may also provide power to other systems and components of machine 10.

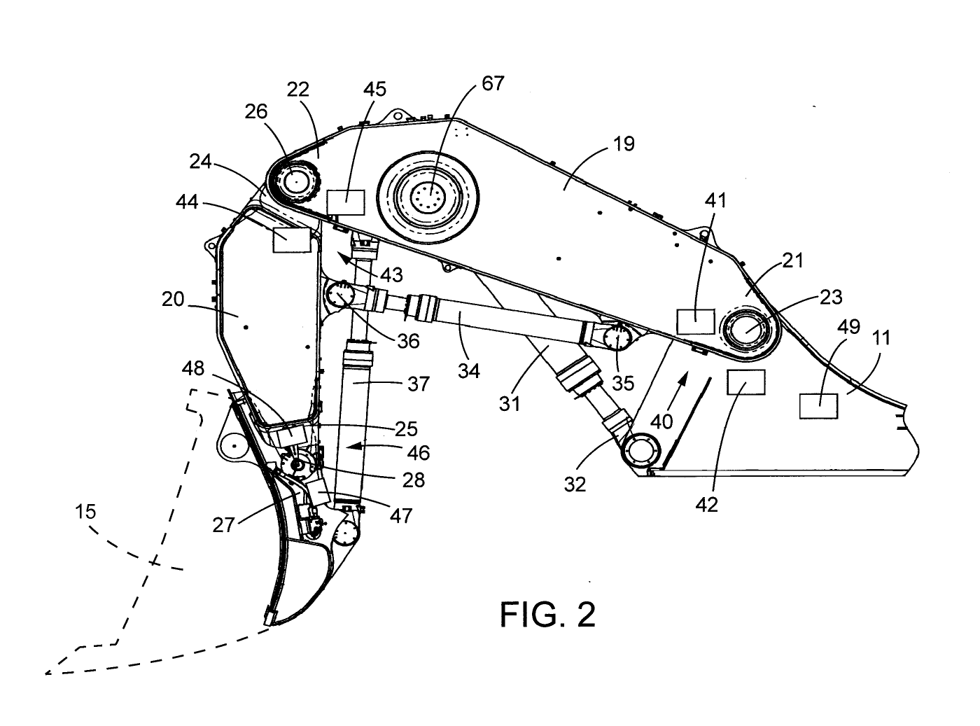

Implement system 14 may include one or more linkage members configured to move a load. In one example, the implement system may include a boom member 19, a stick member 20, and a work implement or tool 15 such as a bucket. A first end 21 (FIG. 2) of boom member 19 may be pivotally connected to platform 11 at boom pivot pin 23 to permit the boom member to pivot or rotate at the boom pivot pin relative to the platform. A second end 22 of boom member 19 may be pivotally connected to a first end 24 of stick member 20 at stick pivot pin 26 to permit the stick member to pivot or rotate at the stick pivot pin relative to the boom member. A first end 27 of the work implement or tool 15 may be pivotally connected to a second end 25 of stick member 20 at tool pivot pin 28 to permit the tool to pivot or rotate at the tool pivot pin relative to the stick member. The linkage members may translate or rotate in a plane that is generally orthogonal to the platform 11.

The linkage members may be operatively connected to an actuator system 30 that includes one or more actuators such as hydraulic cylinders. A pair of generally triangular rocker members 29 (only one being shown in FIG. 1) may be pivotally mounted on opposite sides of boom member 19 at rocker pivot pin 67 to permit the rocker members to pivot or rotate at the rocker pivot pin relative to the boom member. Boom member 19 may be propelled or moved along a path by a pair of boom hydraulic cylinders 31 (only one being shown in FIG. 1). Each boom hydraulic cylinder 31 is pivotally connected at a first end 32 (FIG. 2) to platform 11 and at a second end 33 (FIG. 3) to rocker member 29. Stick member 20 may be propelled by a pair of stick hydraulic cylinders 34. Each stick hydraulic cylinder 34 is pivotally connected at a first end 35 to boom member 19 and at a second end 36 to stick member 20.

A first end 38 of each curl or tool hydraulic cylinder 37 is pivotally connected to a rocker member 29 and a second end 39 is pivotally connected to the tool 15. A stability or steering rod 66 (only one being shown in FIG. 1) extends between the platform 11 and the rocker member 29. Rotation of the tool 15 relative to the stick member 20 may be effected by actuation of the boom hydraulic cylinders 31, the stick hydraulic cylinders 34, and the tool hydraulic cylinders 37.

The rocker members 29 operate in conjunction with the actuator system 30 to provide certain benefits and features. One advantage is that the rocker members 29 combine with the actuator system 30 to limit the extent to which the bucket may rotate backwards when all of the hydraulic cylinders are in their fully extended positions. A second advantage is that the bucket may remain at a constant angle while lifting the bucket. Additional advantages are also provided by the rocker members 29. However, the use of the rocker members 29 in conjunction with the actuator system 30 also results in the possibility of a mechanical conflict or engagement between the stick member 20 and the tool 15. Accordingly, mechanical stops (not shown) may be provided between the stick member 20 and the tool 15 so that any engagement occurs at a desired location that is designed or configured (e.g., reinforced) for the mechanical contact.

In another embodiment that is not depicted, the implement system 14 may not include the rocker members 29 and steering rods 66. In such embodiment, the second end of the boom hydraulic cylinder 31 may be connected directly to the boom member 19 and a first end of the tool hydraulic cylinder 37 may, in some instances, be connected to the stick member 20 and, in other instances, be connected to the boom member.

Each of the boom hydraulic cylinders 31, the stick hydraulic cylinders 34, and the tool hydraulic cylinders 37 may embody a linear actuator as depicted in FIG. 3 having a tubular or cylindrical body and a piston and rod assembly therein arranged to form two distinct pressure chambers. The pressure chambers may be selectively supplied with pressurized fluid and drained of the pressurized fluid to cause the piston and rod assembly to displace within the cylindrical body, and thereby change the effective length of the hydraulic cylinders. The flow rate of fluid into and out of the pressure chambers may relate to the speed of extension or retraction of the hydraulic cylinders while a pressure differential between the two pressure chambers may relate to the force imparted by the hydraulic cylinders to their associated linkage members. The extension and retraction of the hydraulic cylinders results in the movement of the linkage members including tool 15. It is also contemplated that the actuators may alternatively embody electric motors, pneumatic motors, or any other actuation devices.

Swing motor 17 may also be driven by differential fluid pressure. Specifically, swing motor 17 may be a rotary actuator including first and second chambers (not shown) located on opposite sides of an impeller (not shown). Upon filling the first chamber with pressurized fluid and draining the second chamber of fluid, the impeller is urged to rotate in a first direction. Conversely, when the first chamber is drained of fluid and the second chamber is filled with pressurized fluid, the impeller is urged to rotate in an opposite direction. The flow rate of fluid into and out of the first and second chambers affects the rotational speed of swing motor 17, while a pressure differential across the impeller affects the output torque thereof.

Machine 10 may be equipped with a plurality of sensors that provide data, directly or indirectly, of the performance or conditions of various aspects of the machine. The term “sensor” is meant to be used in its broadest sense to include one or more sensors and related components that may be associated with the machine 10 and that may cooperate to sense various functions, operations, and operating characteristics of the machine. Referring to FIG. 2, a pair of sensors is associated with each of the joints between the linkage members with the two sensors of each pair mounted adjacent each other. More specifically, a boom sensor pair 40 includes a boom sensor 41 mounted on boom member 19 adjacent the boom pivot pin 23 and a boom reference sensor 42 mounted on the platform 11 adjacent the boom pivot pin. The boom sensor 41 is configured to generate position signals indicative of a position of the boom member 19 and the boom reference sensor 42 is configured to generate position signals indicative of a position of the platform 11.

A stick sensor pair 43 includes a stick sensor 44 mounted on stick member 20 adjacent the stick pivot pin 26 and a stick reference sensor 45 mounted on the boom member 19 adjacent the stick pivot pin. The stick sensor 44 is configured to generate stick position signals indicative of the position of the stick member 20 and the stick reference sensor 45 is configured to generate stick reference position signals indicative of the position of the boom member 19. A tool sensor pair 46 includes a tool sensor 47 mounted on tool 15 adjacent the tool pivot pin 28 and a tool reference sensor 48 mounted on the stick member 20 adjacent the tool pivot pin. The tool sensor 47 is configured to generate tool position signals indicative of the position of the tool 15 and the tool reference sensor 48 is configured to generate tool reference position signals indicative of the position of the stick member 20. A platform sensor 49 may be mounted on the platform 11 at a location spaced from the boom reference sensor 42. The platform sensor 49 is configured to generate position signals indicative of a position of the platform 11.

Each of the sensors may be position sensors such as inclinometers or tilt sensors in the form of accelerometers that measure the position of the sensors relative to a gravity reference. By measuring the angle of the sensor relative to a gravity reference, the position of the linkage member or component on which they are mounted may be determined. Further, by measuring or calculating the rate of change of the angle of the sensor relative to the gravity reference, the velocity of the linkage members may be determined. If desired, the acceleration of the sensor may also be determined. Regardless of the type of sensor, each of the sensors may be configured to generate output signals and the output signals may be indicative, directly or indirectly of the position, velocity, and acceleration of the sensor.

In one configuration, the sensors may be absolute sensors that provide a unique output for each position of the sensor. By using an absolute sensor, recalibration or re-homing of the sensor is not required each time power is removed, lost or otherwise to go off from the sensor. In an alternate embodiment, the sensors may be incremental or relative sensors that require recalibration or re-homing after a power loss.

Referring to FIG. 3, a control system 55 may be provided to control the operation of the machine 10 including the linkage positioning system of the machine. The control system 55, as shown generally in FIG. 2, may include an electronic control module such as controller 56. The controller 56 may receive operator input commands or signals and control the operation of the various systems of the machine 10. The control system 55 may include one or more operator input devices 57 such as a joystick to control the machine 10 and one or more sensors. The controller 56 may communicate with the sensors, the operator input devices 57, and other components via communication lines 58 or wirelessly.

The controller 56 may be an electronic controller that operates in a logical fashion to perform operations, execute control algorithms, store and retrieve data and other desired operations. The controller 56 may include or access memory, secondary storage devices, processors, and any other components for running an application. The memory and secondary storage devices may be in the form of read-only memory (ROM) or random access memory (RAM) or integrated circuitry that is accessible by the controller. Various other circuits may be associated with the controller such as power supply circuitry, signal conditioning circuitry, driver circuitry, and other types of circuitry.

The controller 56 may be a single controller or may include more than one controller disposed to control various functions and/or features of the machine 10. The term “controller” is meant to be used in its broadest sense to include one or more controllers and/or microprocessors that may be associated with the machine 10 and that may cooperate in controlling various functions and operations of the machine. The functionality of the controller 56 may be implemented in hardware and/or software without regard to the functionality. The controller 56 may rely on one or more data maps relating to the operating conditions of the machine 10 that may be stored in the memory of controller. Each of these maps may include a collection of data in the form of tables, graphs, and/or equations. The controller 56 may use the data maps to maximize the performance and efficiency of the machine 10.

The boom hydraulic cylinders 31, the stick hydraulic cylinder 34, the tool hydraulic cylinder 37, and the swing motor 17 may function together with other cooperating fluid components to move tool 15 in response to input received from the operator input device 57. In particular, control system 55 may include one or more fluid circuits (not shown) configured to produce and distribute streams of pressurized fluid. One or more boom control valves 60, one or more stick control valves 61, one or more tool control valves 62, and one or more swing control valves 63 may be configured or positioned to receive the streams of pressurized fluid and selectively meter the fluid to and from the boom hydraulic cylinders 31, the stick hydraulic cylinder 34, the tool hydraulic cylinder 37, and the swing motor 17, respectively, to regulate the motions thereof.

Controller 56 may be configured to receive input from the operator input device 57 and to command operation of the boom control valves 60, the stick control valves 61, the tool control valves 62, and the swing control valves 63 in response to the input and based on the data maps described above. More specifically, controller 56 may receive an input device position signal indicative of a desired speed and/or type of movement in a particular direction and refer to the data maps stored in the memory of controller 56 to determine flow rate values and/or associated positions for each of the supply and drain elements within the boom control valves 60, the stick control valves 61, the tool control valves 62, and the swing control valves 63. The flow rates or positions may then be commanded of the appropriate supply and drain elements to cause filling and/or draining of the chambers of the actuators at rates that result in the desired movement of tool 15.

The input commands of the operator may be modified based upon the positions and velocity of the boom member 19, the stick member 20, and the tool 15. In order to improve the speed and efficiency of operation, the control system 55 may include a position sensing system generally indicated at 65 in FIG. 3 for accurately determining the position of each of the linkage members and the hydraulic cylinders.

The position sensing system 65 uses the pairs of sensors to reduce the error and/or time delay associated with determining the position and speed of movement of each of the linkage members. As described above, the two sensors of each sensor pair may be positioned relatively close to the respective pivot pin but with each sensor positioned on the different component connected by the pivot pin. For example, the boom sensor 41 may be positioned on the boom member 19 adjacent boom pivot pin 23 and the boom reference sensor 42 positioned on the platform 11 adjacent the boom pivot pin. By positioning the sensors that make up a sensor pair in close proximity to each other, errors created by movement of the sensors such as due to vibrations and other movements affect the two sensors equally and may be eliminated or reduced by subtracting the measurement generated by the reference sensor from the measurement generated by the primary sensor. In one example, each sensor of a sensor pair was positioned between 0.3 m and 1.2 m from a respective pivot pin. In such case, the two sensors were no more than approximately 1.0 m apart. Other distances may be used depending upon the desired accuracy and the operating conditions encountered by machine 10.

Subtracting the measurement generated by the reference sensor from the measurement generated by the primary sensor also provides the relative angle between the two components on which the sensor pair are mounted. In other words, the use of the sensor pair eliminates or greatly reduces error due to vibrations and other movement and also transforms the individual angles measured by each of the sensors from a measurement relative to a gravity reference to a measurement by the sensor pair of the angle between the components on which the sensors are mounted.

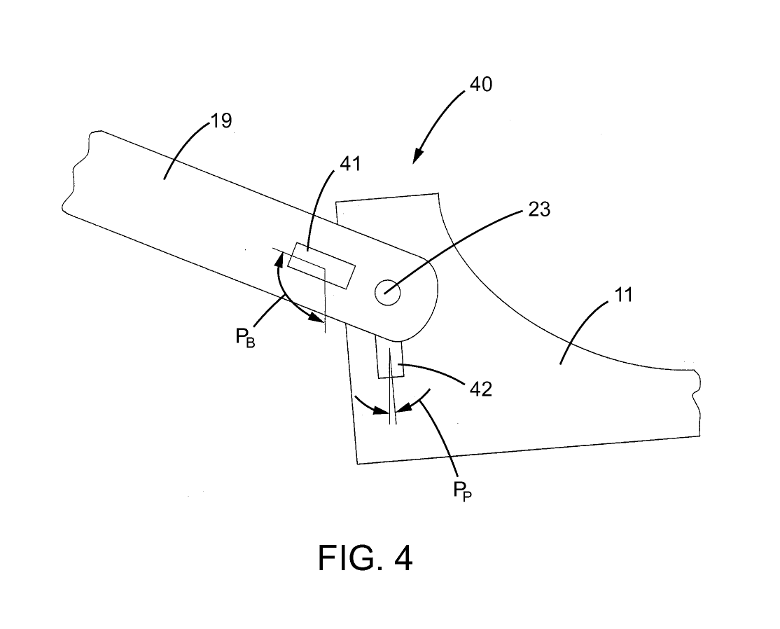

As an example using the boom sensor pair 40, the position of boom member 19 relative to a gravity reference may be determined based upon the output signals from the boom sensor 41. Output signals from the boom sensor 41 may also include movement due to vibrations and other types of machine 10 of the machine. Referring to FIG. 4, the position (P_{SB}) indicated by the boom sensor 41 may be represented by the equation:

P_{SB}=P_{B}+E_{B} (1)

where P_{B} is indicative of the actual angle or position of the boom member 19 relative to a gravity reference and E_{B} equals the angle or position of the boom member due to sensor error caused by vibrations and other accelerations of the boom member. Similarly, the position (P_{SP}) indicated by the boom reference sensor 42 may be represented by the equation:

P_{SP}=P_{P}+E_{P} (2)

where P_{P} is indicative of the actual angle or position of the platform 11 relative to a gravity reference and E_{P} equals the angle or position of the platform due to sensor error caused by vibrations and other accelerations of the platform.

If both the boom sensor 41 and the boom reference sensor 42 are positioned close enough together (such as adjacent the boom pivot pin 23), the movement of the boom sensor and the boom reference sensor will be identical or substantially identical to those reflected by the boom sensor. As a result, subtracting the measurement generated by the boom reference sensor 42 from the measurement generated by the boom sensor 41 will eliminate or substantially eliminate the affect of vibrations and other accelerations on the position measurement process. In other words, subtracting the boom reference measurement from the boom sensor measurement may act as a filter to remove errors due to the vibrations and other movements common to the boom member 19 and the platform 11 that typically occur during the operation of the machine 10.

In addition, while the portion of the signals indicative of actual position of the boom member P_{B} and the actual position of the platform (P_{P}) are both relative to a gravity reference, subtracting the position (P_{SP}) indicated by the boom reference sensor 42 from the position (P_{SB}) indicated by the boom sensor 41 provides a resulting output from the boom sensor pair 40 in the form of the relative angle (P_{R}) between the boom member 19 and the platform 11. This may be represented by the equation:

P_{R}=P_{SB}−P_{SP} (3)

Substituting equations (1) and (2) for the position (P_{SB}) and the position (P_{SP}), respectively, results in:

P_{R}=(P_{P}+V_{P})−(P_{B}+V_{B}) (4)

Since E_{B}=E_{P} provided that the boom sensor 41 and the boom reference sensor 42 are close enough together, equation (4) may be simplified to:

P_{R}=P_{B}−P_{P} (5)

As a result, the relative angle (P_{R}) represented by the difference between the signals from the boom sensor 41 and the boom reference sensor 42 is the actual relative angle between the boom member 19 and the platform 11 with the affects of vibrations and other movements common to the boom member and platform eliminated.

If desired, the signals from the boom sensor 41 and the boom reference sensor 42 may be used to determine the rate of change or velocity of the boom member 19 relative to the platform 11 as well as the relative acceleration between the components.

The stick sensor pair 43 and the tool sensor pair 46 may operate in a similar manner. The stick sensor pair 43 may be used to determine the relative angle, velocity and acceleration between the boom member 19 and the stick member 20 while the tool sensor pair 46 may be used to determine the relative angle, velocity, and acceleration between the stick member 20 and the tool 15.

Data maps within controller 56 may store or specify the position of each of the linkage members based upon the relative positions as determined by the boom sensor pair 40, the stick sensor pair 43, and the tool sensor pair 46. That is, the dimensions of each of the linkage members and the relative angles at the joints or intersection of the linkage members as determined by the boom sensor pair 40, the stick sensor pair 43, and the tool sensor pair 46 may be used to determine the actual position of each linkage member. More specifically, the relative angle determined by the boom sensor pair 40 coupled with the dimensions of the boom member 19 and the location of boom pivot pin 23 define the position of the boom member and the stick pivot pin 26. The relative angle determined by the stick sensor pair 43 coupled with the dimensions of the stick member 20 and the location of stick pivot pin 26 define the position of the stick member and the tool pivot pin 28. The relative angle determined by the tool sensor pair 46 coupled with the dimensions of the tool 15 and the location of stick pivot pin 26 define the position of the tool 15 and the tool pivot pin 28.

In addition, the positions or percent of stroke of each of the hydraulic cylinders may also be stored or specified within data maps within controller 56 based upon the positions of the linkage members and the relative angles at the joints or intersection of the linkage members as determined by the boom sensor pair 40, the stick sensor pair 43, and the tool sensor pair 46. The positions or percent of stroke of the hydraulic cylinders may be determined based upon their dimensions and the mounting points of the cylinders on the linkage members and the platform 11.

Although described with each sensor pair having the sensors mounted on two different components that are movable relative to each other. It may be possible to include the pair of sensors on the same component and provide a mechanism to differentiate between vibration-type movements and translational movement such as movement of a linkage member. For example, it may be possible to orient a reference sensor in a different manner from the main sensor to permit differentiation between the types of movement.

As described above, the controller 56 may operate by analyzing the output or data from the sensors to determine the positions of the linkage members and the hydraulic cylinders without actually calculating the angles between the components. In other words, the data maps may be configured to determine the positions of the linkage members and the hydraulic cylinders based upon the actual signals or data from the sensors without additional processing to determine the angles between the linkage members. If desired, the controller 56 may be configured to determine the actual angles and the data maps configured to generate the positions of the linkage members and the hydraulic cylinders based upon those angles. In addition, if desired, the controller 56 may be configured to operate based upon the angles of the linkage members relative to a gravity reference rather than based upon relative angles between components of the linkage members. Further, if desired, the position of the boom member 19 relative to the platform 11 may be stored within the controller 56 as data representative of an angle between the boom member and the platform, the position of the stick member 20 relative to the boom member 19 may be stored within the controller as data representative of an angle between the stick member and the boom member, and the position of the tool 15 relative to the stick member may be stored within the controller as data representative of an angle between the tool and the stick member.

To generate the data maps based upon the positions of the sensors, the linkage members may be moved to one or more known positions and the relative angle generated by each of the boom sensor pair 40, the stick sensor pair 43, and the tool sensor pair 46 stored within the controller 56. For example, the hydraulic cylinders may be moved to their fully extended positions to move each of the linkage members to their fully extended positions. Data from the platform sensor 49 may be used to establish the tilt and roll of the platform 11 relative to a ground reference to increase the accuracy of the data maps since the tilt and roll of the platform will affect the data generated by the boom sensor pair 40, the stick sensor pair 43, and the tool sensor pair 46. The data maps may be completed based upon the dimensions of the linkage members, the positions of the pivot pins connecting the linkage members, and the dimensions of the hydraulic cylinders. In some instances, it may be desirable to generate the data maps based upon additional positions. When using absolute sensors rather than incremental sensors, it generally is not necessary to recalibrate or regenerate the data maps absent changes in the mechanical structure of the machine 10 such as a change in the tool 15 or replacement of the sensors.

The data maps may store a plurality of mechanical conflict positions that correspond to undesired positions of the boom member 19, stick member 20, and tool 15 at which any of the linkage members travel into the same physical space. Additional mechanical conflict positions include positions at which any of the hydraulic cylinders are moved to their end of travel positions. These mechanical conflict positions may be generated based upon the dimensions of the components and the kinematics of the machine 10 and may be stored in a data maps in any form. In one example, the mechanical conflict positions may be stored as readings from the boom sensor pair 40, the stick sensor pair 43, and the tool sensor pair 46. In another example, the mechanical conflict positions may be stored in the controller 56 based upon the position of each of the platform 11, boom member 19, stick member 20, and the tool 15.

In operation, an operator may move an input device to generate a desired input command to move the tool 15 in a desired manner. As the linkage members move, signals generated by the boom sensor pair 40 may be used by controller 56 to determine the relative angle, and its rate of change, between the boom member 19 and the platform 11, signals generated by the stick sensor pair 43 and the stick reference sensor 45 may be used to determine the relative angle, and its rate of change, between the stick member 20 and the boom member, and signals generated by the tool sensor pair 46 may be used to determine the angle, and its rate of change, between the tool 15 and the stick member.

The controller 56 may determine the proximity of each of the linkage members and the hydraulic cylinders to a mechanical conflict position. More specifically, the controller 56 may determine the proximity of each linkage member to engagement with another component of the machine 10 and the proximity of each hydraulic cylinder to an end of travel position as well as the rate at which the linkage members are moving. If the desired input command would result in moving the linkage members in a manner that will result in a mechanical conflict (i.e., any linkage component engaging another component of the machine 10 or any hydraulic cylinder reaching its end of travel positions), the controller 56 may decrease or retard the rate at which one or more components of the machine is moving to prevent or reduce the impact of the mechanical conflict. In other instances, the controller 56 may command additional movements of components to avoid a mechanical conflict. For example, the controller 56 may generate commands to retract the tool hydraulic cylinders 37 as the stick hydraulic cylinders 34 are slowed.

### INDUSTRIAL APPLICABILITY

The industrial applicability of the position sensing system 65 described herein will be readily appreciated from the foregoing discussion. The present disclosure is applicable to many machines and tasks performed by machines. One exemplary machine for which the position sensing system 65 is suited is an excavator or hydraulic shovel. However, the position sensing system 65 may be applicable to other machines and material handling systems that benefit from precise control of a tool 15 near an end of travel or mechanical conflict position.

The disclosed position sensing system 65 provides many advantages while operating a machine. The precision afforded by the sensor pairs of the position sensing system 65 permits the controller 56 to be configured to allow the linkage members to move as rapidly as possible without reaching a mechanical conflict position. This permits an operator to maximize the efficiency of the machine operation without excessively slowing the linkage members as they approach a mechanical conflict and by preventing or minimizing such mechanical conflicts to reduce wear on the machine 10. The position sensing system 65 permits the reduction or elimination of positioning errors caused by vibrations and other similar movements without the need for complex filtering processes that are relatively time consuming and may reduce the accuracy of the position signals.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

1. A system for determining a position of a first component relative to a second component, comprising:
a first component;
a second component pivotably mounted to the first component and movable relative to the first component;
a first sensor mounted on the first component and configured to generate first position signals indicative of a position of the first component;
a reference sensor mounted on the second component and positioned adjacent the first sensor and configured to generate reference position signals indicative of a position of the second component; and
a controller configured to:
receive the first position signals;
receive the reference position signals; and
determine a position of the first component relative to the second component based upon both the first position signals and the reference position signals.

2. The system of claim 1, wherein the controller is configured to determine the position of the first component relative to the second component based upon a difference between the position of the first component as determined by the first sensor and the position of the second component as determined by the reference sensor.

3. The system of claim 1, further including a pivot pin about which the first component rotates relative to the second component and wherein the first sensor and the reference sensor are positioned adjacent the pivot pin.

4. The system of claim 1, wherein the first sensor and the reference sensor are both inclinometers.

5. The system of claim 1, wherein the first sensor is configured to generate the first position signals relative to a gravity reference and the reference sensor is configured to generate the reference position signals relative to the gravity reference.

6. The system of claim 5, wherein the controller is further configured to subtract the reference position signals from the first position signals to determine the position of the first component relative to the second component.

7. The system of claim 1, wherein the first sensor and the reference sensor are both absolute sensors.

8. The system of claim 1, wherein the first component is a boom member, the second component is a platform, and the boom member is mounted to rotate relative to the platform about a boom pivot pin, and further including:
a stick member pivotably mounted to the boom member to rotate relative to the boom member about a stick pivot pin;
a tool pivotably mounted to the stick member to rotate relative to the boom member about a tool pivot pin;
a stick sensor mounted to the stick member and a stick reference sensor mounted to the boom member adjacent the stick sensor, the stick sensor being configured to generate stick position signals indicative of a position of the stick member and the stick reference sensor being configured to generate stick reference position signals indicative of a position of the boom member;
a tool sensor mounted to the tool and a tool reference sensor mounted to the stick member adjacent the tool sensor, the tool sensor being configured to generate tool position signals indicative of a position of the tool and the tool reference sensor being configured to generate tool reference position signals indicative of a position of the stick member; and
the controller is further configured to determine a position of the stick member relative to the boom member based upon both the stick position signals and the stick reference position signals and determine a position of the tool relative to the stick member based upon both the tool position signals and the tool reference position signals.

9. The system of claim 8, wherein the position of the boom member relative to the platform is an angle between the boom member and the platform, the position of the stick member relative to the boom member is an angle between the stick member and the boom member, and the position of the tool relative to the stick member is an angle between the tool and the stick member.

10. The system of claim 8, wherein the position of the boom member relative to the platform is data representative of an angle between the boom member and the platform, the position of the stick member relative to the boom member is data representative of an angle between the stick member and the boom member, and the position of the tool relative to the stick member is data representative of an angle between the tool and the stick member.

11. The system of claim 8, wherein the first sensor and the reference sensor are mounted adjacent the boom pivot pin, the stick sensor and the stick reference sensor are mounted adjacent the stick pivot pin, and the tool sensor and the tool reference sensor are mounted adjacent the tool pivot pin.

12. The system of claim 11, wherein the controller is further configured to store a plurality of mechanical conflict positions, determine positions of each of the boom member, the stick member, and the tool, and determine whether any of the boom member, the stick member, and the tool are in proximity to one of the plurality of mechanical conflict positions.

13. The system of claim 12, wherein a mechanical conflict occurs when the boom member and stick member travel into the same physical space.

14. The system of claim 12, further including a plurality of actuators configured to move the boom member, the stick member, and the tool, and wherein a mechanical conflict occurs when one of the plurality of actuators reaches its end of travel position.

15. The system of claim 8, further including a platform sensor mounted on the platform to determine a position of the platform relative to a gravity reference, the platform sensor being spaced from the reference sensor.

16. A controller-implemented system for determining a position of a first component relative to a second component, comprising:
receiving first position signals from a first sensor mounted on a first component;
receiving reference position signals from a reference sensor mounted on a second component;
pivoting the first component relative to the second component; and
determining a position of the first component relative to the second component based upon both the first position signals and the reference position signals.

17. The method of claim 16, further including generating the first position signals relative to a gravity reference and generating the reference position signals relative to the gravity reference.

18. The method of claim 17, further including subtracting the reference position signals from the first position signals when determining the position of the first component relative to the second component.

19. The method of claim 17, further including receiving additional position signals from an additional sensor mounted on the second component but spaced from the reference sensor.

20. A machine comprising:
a prime mover;
a first component;
a second component pivotably mounted to the first component and movable relative to the first component;
a first sensor mounted on the first component and configured to generate first position signals indicative of a position of the first component;
a reference sensor mounted on the second component and positioned adjacent the first sensor and configured to generate reference position signals indicative of a position of the second component; and
a controller configured to:
receive the first position signals;
receive the reference position signals; and
determine a position of the first component relative to the second component based upon both the first position signals and the reference position signals.
